(19) United States
(12) Patent Application Publication
(10) Pub. No.: US 2015/0062982 A1
(43) Pub. Date: Mar. 5, 2015

(54) Circuit Arrangement and Method for Actuating at Least One Switching Element of a Voltage Converter

(71) Applicant: SMA Solar Technology AG, Niestetal (DE)

(72) Inventors: Burkard Mueller, Kassel (DE); Lukas Kasper, Kassel (DE)

(21) Appl. No.: 14/534,380

(22) Filed: Nov. 6, 2014

Related U.S. Application Data
(63) Continuation of application No. PCT/EP2013/059405, filed on May 6, 2013.

(30) Foreign Application Priority Data
May 10, 2012 (DE) 10 2012 104 103.2

(51) Int. Cl. H02M 1/08; H02M 3/335

(52) U.S. Cl. CPC H02M 1/08; H02M 3/33576
USPC 363/21.18

(57) ABSTRACT

The disclosure relates to a circuit arrangement for actuating at least one switching element of a voltage converter with a DC-isolating signal transformer that comprises a primary winding and at least one secondary winding, wherein an actuating signal for the switching element can be applied to the primary winding, and the secondary winding is connected to a switching input of the at least one switching element. The circuit arrangement is characterized by the fact that at least a part of the at least one secondary winding is connected in series with a switching path of the switching element in such a way that a switch current flowing through a switching path of the switching element flows through this part, and that a current measurement device is arranged in a series circuit with respect to the primary winding for determining the switch current. The disclosure furthermore relates to a method for actuating a switching element of a voltage converter, to a driver circuit for providing the actuating signal, which driver circuit can be used in connection with the circuit arrangement, and to the use of the circuit arrangement and/or of the method for providing an operating supply voltage to an inverter.

### REFERENCE TO RELATED APPLICATION

This application is a continuation of international application number PCT/EP2013/059405 filed on May 6, 2013, which claims priority to German application number 10 2012 104 103.2 filed on May 10, 2012.

### FIELD

The disclosure relates to a circuit arrangement for actuating at least one switching element of a voltage converter. The circuit arrangement has a DC (direct current)-isolating signal transformer, with a primary winding and at least one secondary winding, wherein an actuating signal for the switching element can be applied to the primary winding, and the secondary winding is connected to a switching input of the at least one switching element. The disclosure further relates to a method for actuating a switching element of a voltage converter and to a driver circuit for providing the actuating signal, which driver circuit can be used in connection with the circuit arrangement.

### BACKGROUND

Voltage converters that are generally clocked can also be referred to as DC/DC converters or can be implemented as voltage converters with an AC input, which are also referred to as AC/DC converters. DC/DC converters find widespread use in power supply applications, for example as part of power supply units or as an input stage of an inverter or for providing an on-board power supply to an inverter. Both DC/DC converters with a fixed potential reference, such as step-up converters, step-down converters etc., and DC-isolating DC/DC converters are conventional. The latter are in this case configured as flyback converters or forward converters, for example, and have at least one switching element, whose switching path is arranged in a power circuit of the DC/DC converter. Examples of switching elements which are used are MOSFETs (Metal Oxide Semiconductor Field-Effect Transistors), JFETs (Junction FETs) or IGBTs (Insulated-Gate Bipolar Transistors) or other transistors.

In the case of a DC/DC converter, the switching element is typically actuated by a pulse-width-modulated (PWM) actuating signal, wherein various, usually integrated driver circuits are available for this purpose. In order to be able to operate the driver circuits in DC-isolated (also called galvanically isolated) fashion from the power circuit of the DC/DC converter, the actuating signal can be transmitted from the driver circuit to a switching input of the switching element in a known manner via a DC-isolating transformer. Such actuation via a signal transformer is described, for example, in document U.S. Pat. No. 6,169,681 B1 in connection with a switched mode power supply. A further switched mode power supply with a transformer for the actuation signal is described in document U.S. Pat. No. 4,744,020. The power supply implements a so-called “proportional base driving circuit”, where an additional winding on the transformer is part of the switching path and is used to keep the switching element conductive.

DC/DC converters are often operated in the so-called “current mode”, in which a switch current flowing in the power circuit through the switching element of the DC/DC converter is used as an actuating variable for the generation of the actuating signal. As is known, for example, from the document U.S. 2012/0020121 A1, a further transformer can be provided in the power circuit for this purpose in order to be able to measure the switch current with DC isolation and to provide the measured value to the driver circuit.

An arrangement with a signal transformer for the actuating signal and a transformer for the DC-isolated measurement of the switch current is disadvantageous owing to the number of transformers required. This applies in particular when the DC/DC converter has a plurality of primary power circuits. A plurality of primary power circuits provide the possibility of supplying the output of the DC/DC converter from a plurality of voltage sources at different potentials simultaneously or alternatively.

### SUMMARY

One embodiment of the present disclosure comprises a circuit arrangement for actuating at least one switching element of a voltage converter of the type mentioned at the outset, in which a current measurement is realized in a simple manner without any considerable additional complexity in terms of circuitry, in particular without any additional transformers. Another embodiment comprises a method for actuating a switching element in such a circuit arrangement and providing a driver circuit which can be used in connection with the circuit arrangement.

A circuit arrangement according to the disclosure of the type mentioned at the outset is characterized by the fact that at least part of the at least one secondary winding is connected in series with a switching path of the switching element in such a way that a switch current flowing through a switching path of the switching element flows through this part, and that a current measurement device is arranged in a series circuit with respect to the primary winding for determining the switch current.

Owing to the fact that the signal transformer acts with its secondary winding not only on the control input of the switching element but is part of the power circuit and has the switch current flowing through it, the signal transformer can be used for the back-transformation of the switch current onto the primary side of the signal transformer, and thus a measurement of the switch current can take place on the primary side via the current measurement device. The signal transformer therefore acts simultaneously as an actuating transformer for the actuating signal of the switching element and as a measured value transformer for the switch current measurement. This dual use saves on material and costs and can contribute to a reduction in the physical size of the circuit arrangement and therefore of the voltage converter.

In an advantageous configuration, the circuit arrangement comprises at least two power circuits, each comprising at least one switching element for connection to different voltage sources. In this case, a signal transformer with a primary winding and separate secondary windings for the switching elements is provided or separate signal transformers each comprising a primary winding and a secondary winding are provided. In both cases, the back-transformed switch currents are added together and can easily be measured jointly. Control of a voltage converter with two voltage sources can then take place in the “current mode” in a simple manner using the measured total signal, for example.

In a further advantageous configuration of the circuit arrangement, the at least one secondary winding is a winding with a tap, wherein the secondary winding is connected in series with the switching path of the at least one switching element from an end connection up to the tap, whereas a remaining part or the entire secondary winding is operatively connected to the switching input of the at least one switching element. This makes it possible to reduce the level of the back-transformed current in the primary winding by a freely selectable ratio, which is dependent on the turns ratio of the various parts of the secondary winding, given the same value for the control voltage. This can be used, for example, to reduce the current loading in a circuit for generating the actuating signal or to increase the measurement accuracy during the current measurement.

A driver circuit is used for providing a pulse-width-modulated actuating signal for at least one switching element of a voltage converter at a primary winding of a DC-isolating signal transformer, which comprises at least one secondary winding connected to a control input of the switching element. According to the disclosure, the driver circuit is configured to evaluate a current flowing through the primary winding as a signal corresponding to a switch current flowing through the switching element. The driver circuit is thus designed for use with the abovementioned circuit arrangement and makes it possible to measure the switch current which has been back-transformed onto the primary side of the signal transformer. This results in the advantages mentioned in connection with the circuit arrangement.

Advantageously, the driver circuit is in the form of an integrated circuit and can therefore be used in a voltage converter in a space-saving manner and with little complexity.

In other advantageous configurations, the driver circuit comprises a current measurement device for detecting the current flowing through the primary winding or has terminals to an external current measuring device for detecting the current flowing through the primary winding. In both cases, terminals for an external shunt can be provided as part of the current measurement device.

A method according to the disclosure for actuating at least one switching element of a voltage converter via a DC-isolating signal transformer, which has a primary winding and at least one secondary winding, wherein an actuating signal for the switching element is applied to the primary winding, and the secondary winding provides a switching signal for the at least one switching element, is characterized by the fact that a switch current flowing through the switching path of the switching element is transferred to the primary winding via the signal transformer, and in that a current flowing through the primary winding is detected as a measure of the switch current.

As a result, according to the disclosure, an actuating signal is therefore generated and transmitted from a primary side to a secondary side via the signal transformer. The actuating signal controls the switching element and therefore influences the switch current. The resultant change in the switch current is transmitted from the secondary side of the signal transformer to the primary side as a current signal and is detected on the primary side. This again results in the advantages mentioned in connection with the circuit arrangement.

The value of the switch current detected on the primary side can then be used as an actuating variable for generating the actuating signal, in an advantageous configuration of the method.

According to the disclosure, the circuit arrangement and/or the driver circuit and/or the method is/are used for providing an operating supply voltage to an inverter.

### BRIEF DESCRIPTION OF THE DRAWINGS

The disclosure will be explained in more detail below with reference to embodiments with the aid of four figures, in which:

FIGS. 1 to 3 each show an embodiment of a circuit arrangement in accordance with the application in a DC/DC converter, and

FIGS. 4a-4c show various configurations of a signal transformer for a circuit arrangement in accordance with the application.

### DETAILED DESCRIPTION

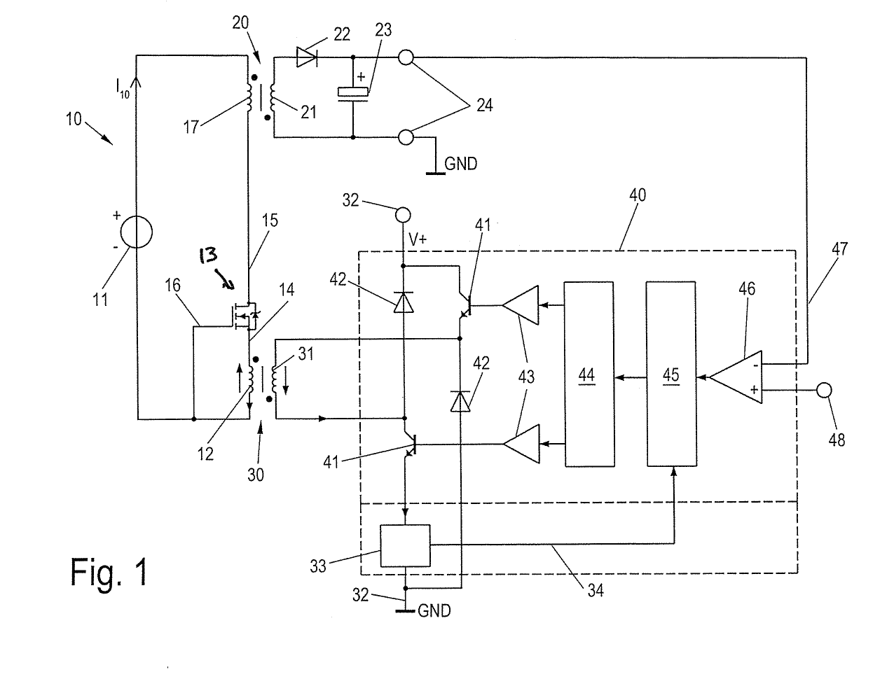

FIG. 1 shows a schematic diagram of a DC/DC converter with a circuit arrangement in accordance with the application in a first embodiment.

The DC/DC converter comprises a power circuit 10, in which a voltage source 11 with a switching element 13 and a primary winding 17 of a power transformer 20 are arranged. A switch current I₁₀ flows in the power circuit 10. The switching element 13 has a switching path between switching connections 14 and 15, and a control input 16. In the example illustrated, the switching element 13 is a MOSFET with a source and a drain as switching connections 14, 15 of the switching path and a gate as control input 16. For reasons of a simplified illustration, the connections of the switching element 13 are referred to as source 14, drain 15 and gate 16 below.

The power transformer 20 also has a secondary winding 21, which is connected via a diode 22 to a smoothing capacitor 23 and to output connections 24, which are in parallel with said smoothing capacitor. Given clocked actuation of the switching element 13 and correspondingly pulsed current flow through the primary winding 17 of the power transformer 20, an output voltage is induced in the secondary winding 21, which output voltage is provided, rectified by the diode 22, via the smoothing capacitor 23 as an output voltage of the DC/DC converter at the output connections 24.

The voltage converter illustrated in FIG. 1 is a DC-isolating flyback converter. However, the disclosure can likewise be used for other types of DC/DC converters, for AC/DC converters and also for DC-to-AC converters.

For the pulsed actuation of the switching element 13, in addition a secondary winding 12 of a signal transformer 30 is provided between the source 14 and the gate 16. This secondary winding, in contrast to that known from the prior art, is arranged in the power circuit 10, i.e. the switch current I₁₀ flows through said secondary winding. On the primary side, the signal transformer 30 has a primary winding 31, which is connected to a PWM driver circuit 40 which in one embodiment is implemented as an integrated circuit. In order to actuate the primary winding 31 of the signal transformer 30, a bridge circuit is provided in the PWM driver circuit 40, which bridge circuit is in the form of an H-bridge with two actively actuable bridge switches 41 and two passive bridge diodes 42. The H-bridge and also the further components in the PWM driver circuit 40 are supplied with current via power supply connections 32. In the figure, the power supply is symbolized by a positive potential V+ and a ground potential GND at the power supply connections 32. The power supply can take place, for example, during operation via the output voltage of the DC/DC converter which is present at the output connections 24. In order to start the DC/DC converter, an additional auxiliary voltage source is then generally provided, for example a linear controller, which is fed from the voltage source 11.

The bridge switches 41 are switched via driver modules 43 of a PWM generator 44, which is in turn connected to a control device 45 controlling the PWM generator 44. The PWM driver circuit 40 furthermore comprises a comparator 46, which has an actual voltage input 47 and a setpoint voltage input 48. A desired output voltage of the DC/DC converter at the output connections 24 is preset at the setpoint voltage input 48. The actual voltage input 47 is correspondingly connected to one of the outputs 24 of the DC/DC converter. The function of the comparator 46 for regulating the output voltage of the DC/DC converter can also be integrated into the control device 45 and take place there in analog or digital fashion.

During operation of the DC/DC converter, the output voltage of the DC/DC converter is therefore applied to the actual voltage input 47, and the output voltage is compared with the setpoint voltage. The output of the comparator 46 controls the PWM generator 44 via the control device 45 in such a way that the bridge switches 41 are switched in clocked fashion such that the desired setpoint voltage is set at the output connections 24 of the DC/DC converter. In this case, the bridge switches 41 are each switched on or switched off in parallel. A current flow in the reverse direction through the primary winding 31 via the bridge diodes 42 is possible in the switch-off phases of the bridge switches 41. The AC voltage resulting from the clocking at the primary winding 31 of the signal transformer 30 is transmitted to the secondary winding 12 of the signal transformer 30 and results in an AC voltage signal between the source 14 and the gate 16 of the switching element 13. Said switching element 13 is switched on and off in pulsed fashion corresponding to the operation of the DC/DC converter.

With the pulsed switching of the switching element 13, an alternating current I₁₀ flows in the power circuit 10. Since the secondary winding 12 of the signal transformer 30 is part of the power circuit 10, the alternating switch current I₁₀ brings about an additional current flow in the primary winding 31 of the signal transformer 30. A current measurement device 33 is integrated in the bridge circuit of the PWM driver circuit 40, where the current measurement device comprises a shunt, for example. There is a voltage drop across the shunt which is representative of the switch current I₁₀ in the power circuit 10. Instead of a shunt, another current measurement device, for example a Hall sensor, can also be provided. The current measurement device can in this case be incorporated in the PWM driver circuit 40 or else be arranged external thereto.

The voltage drop across the shunt is supplied to the PWM generator 44 as a measured variable via a current measurement input 34 for said PWM generator being able to monitor the actuation of the switching element 13, for example in the abovementioned “current mode”. Owing to the fact that the signal transformer 30 with its secondary winding 12 not only acts on the control input (gate) 16 of the switching element 13 but is part of the power circuit 10, the signal transformer 30 can be used for the back-transformation of the switching current I₁₀ onto the primary side of the signal transformer 30 and thus result in a measurement of the switch current I₁₀ on the primary side via the current measurement device 33. The signal transformer 30 therefore simultaneously acts as an actuating transformer for the actuating signal of the switching element 13 and as a measured value transformer for the switch current measurement.

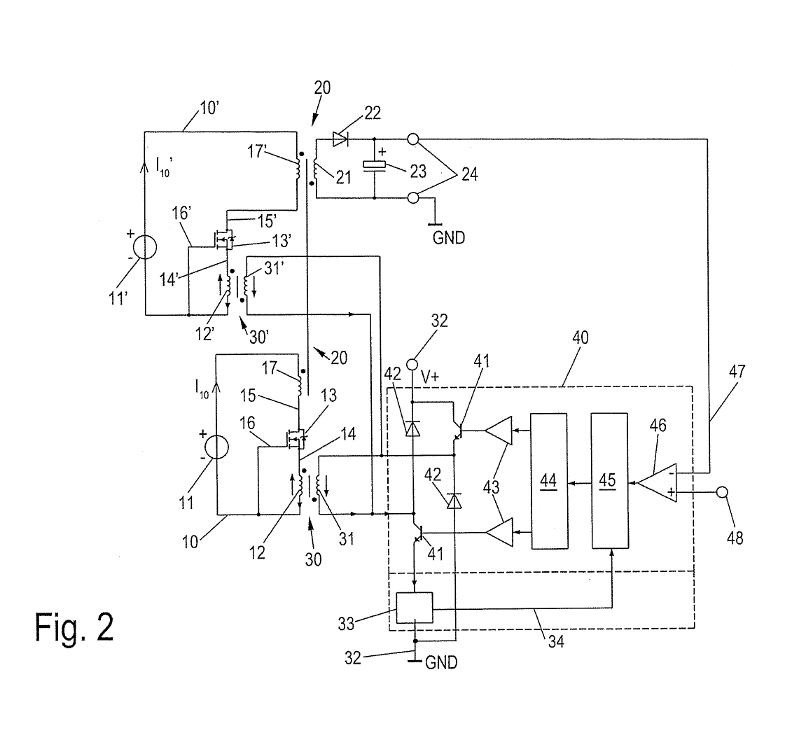

FIG. 2 illustrates a further embodiment of a DC/DC converter as an extension of the DC/DC converter in the first embodiment in FIG. 1. In this embodiment, identical reference symbols denote identical or functionally identical elements to those in the example in FIG. 1.

In contrast to the embodiment in FIG. 1, in this case two power circuits 10, 10′ are provided, which, in this example, are each designed identically and as shown in the first embodiment in FIG. 1. The two power circuits 10, 10′ make it possible for two voltage sources 11, 11′ to be used for supplying power to one output circuit with the output connections 24. In order to distinguish between the two power circuits 10, 10′, all of the components in the power circuit 10′ have been provided with an apostrophe in their reference symbol.

In the DC/DC converter, a common power transformer 20 is provided which has separate primary windings 17, 17′. Furthermore, separate signal transformers 30, 30′ are provided, which correspondingly have separate secondary windings 12, 12′. Owing to the separate primary windings 17, 17′ of the power transformer 20 and the separate signal transformers 30, 30′, the power circuits 10, 10′ are completely DC-isolated from one another and from the rest of the components in the circuit.

A PWM driver circuit 40, which is configured as in the first embodiment in FIG. 1, is provided for both power circuits 10, 10′ and therefore for actuating the two switching elements 13, 13′. Reference is hereby made to the corresponding description. The primary windings 31, 31′ of the signal transformers 30, 30′ are connected in parallel, with the result that, firstly, the two switching elements 13, 13′ are switched simultaneously and, secondly, the back-transformed switch currents I₁₀, I₁₀′ in the bridge circuit of the PWM driver circuit 40 are added to one another, as a result of which a total current across the shunt is measured. Irrespective of whether a load at the connections 24 of the DC/DC converter is supplied from the first voltage source 11, from the second voltage source 11′ or from both voltage sources 11, 11′ to identical or unidentical parts, the total switch current (I₁₀+I₁₀′) is measured by the current measurement device 33.

Given different dimensioning of the signal transformers 30 and 30′, the contributions of the current sources 11 and 11′ to the switch current measured by the current measurement device 33 can be weighted differently. It is likewise conceivable for the actuation to be matched to different switch types by individual dimensioning of the signal transformers 30, 30′.

In the embodiment illustrated, two separate signal transformers 30, 30′ are used. However, it is likewise possible to use a signal transformer 30 with a common primary winding 31 and two separate secondary windings 12, 12′.

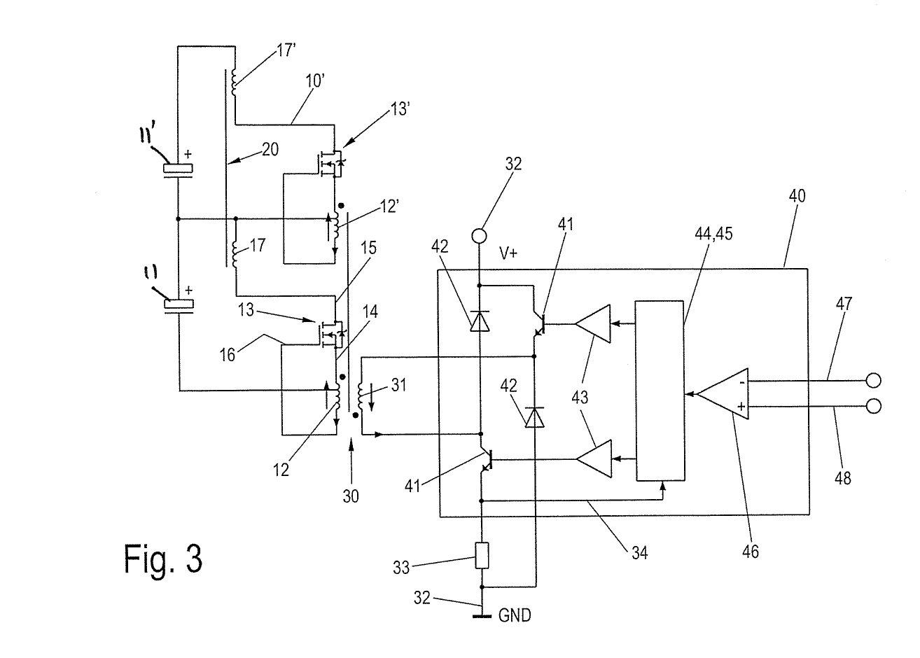

FIG. 3 shows a further DC/DC converter with a circuit arrangement in accordance with the application. Identical reference symbols denote identical or functionally equivalent elements to those in the preceding embodiments in this case too.

In the same way as in the embodiment in FIG. 2, two power circuits 10. 10′ are provided, but in this case said power circuits are not completely DC-isolated, but have series-connected voltage sources 11, 11′. Such a situation is often present in the case of inverters with symmetrical intermediate circuits, wherein the two voltage sources 11, 11′ represent the intermediate circuits or intermediate circuit capacitances. For reasons of clarity, only the primary side with the primary windings 17, 17′ of the DC/DC converter is illustrated; a secondary winding 21 with a downstream diode 22 and buffer capacitor 23 can be provided, for example, in similar fashion to the embodiments in FIGS. 1 and 2.

With respect to the PWM driver circuit 40, reference is again made to the above embodiments. In this case, a common signal transformer 30 with a primary winding 31 is provided. On the secondary side, two secondary windings 12, 12′ are arranged in the signal transformer 30 in order to be able to compensate for the potential difference in the power circuits 10, 10′.

In this case, the secondary windings 12, 12′ are in the form of windings with a tap, wherein the tap is connected in each case to the voltage source 11, 11′ and one of the end connections is connected to the respective source connection 14, 14′ and the other end connection is connected to the respective gate 16, 16′.

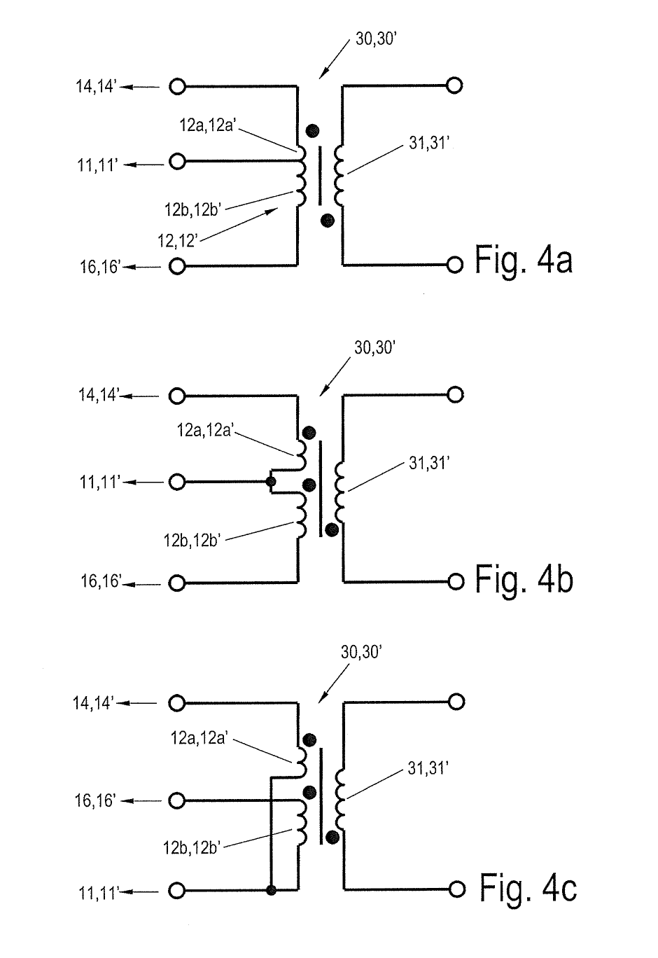

By way of example, FIG. 4a illustrates the signal transformer 30 or 30′ with its tap, in enlarged form for illustrative purposes. Only one part 12a or 12a′ of the secondary winding 12, 12′ is arranged in the power circuit 10, 10′, whereas the entire secondary winding 12, 12′ is present between the source 14, 14′ and the gate 16, 16′, however. As shown in FIG. 4a, the entire secondary winding 12, 12′ comprises the mentioned part 12a, 12a′ and a part 12, 12b′. In this case, the number of winding turns in the power circuit 10, 10′ (part 12a) is in one embodiment lower than the number of remaining winding turns (part 12b). For example, a ratio of 1 to 10 can be selected. This means that, given the same value for the control voltage between the source 14, 14′ and the gate 16, 16′, the level of the back-transformed current in the primary winding 31, 31′ is reduced by this turns ratio. This reduces the current loading in the bridge switches 41 and the bridge diodes 42.

Further possible configurations of the secondary winding 12 or 12′ of the signal transformer 30, 30′ are illustrated in FIGS. 4b and 4c. Instead of the respective secondary winding 12, 12′ with the tap, the parts 12a, 12b or 12a′, 12b′ can be formed as separate windings with terminals connected to one another correspondingly outside the signal transformer 30, 30′. In the example in FIG. 4b, the part 12a, 12a′ is in the power circuits 10, 10′ and the series circuit comprising the parts 12a and 12b or 12a′ and 12b′ is used for actuating the gate 16, 16′. In the example in FIG. 4c, however, the winding 12a, 12a′ is in the power circuit 10, 10′, but the actuation of the gate 16, 16′ only takes place by means of the part 12b, 12b′. In the embodiment of the signal transformer 30, 30′ with the tap or with isolated parts 12a, 12b or 12a′, 12b′, said parts can have a different wire cross section in a simple manner. It is thus possible for different current loadings in the two parts 12a, 12b or 12a′, 12b′ of the secondary winding 12, 12′ to be taken into consideration and for material to be saved in the winding part which is not subjected to such severe current loading, generally the part 12b, 12b′ used for the actuation.

The configurations of the secondary windings 12, 12′ shown in FIGS. 3 and 4a-4c make it possible, furthermore, to use a power transformer 20 with primary windings 17, 17′ with different turns numbers, for example in order to feed different voltages to the DC/DC converters from voltage sources 11, 11′ and/or to favor one of the voltage sources 11, 11′. Since primary windings 17, 17′ of the power transformer 20 with different turns numbers transmit different powers with the same current, the current transformation ratio which can be matched via the tap of the secondary windings 12, 12′ can be used at this point as possible correction means, even when the actuating signals for switching the switching elements 13, 13′ are transmitted with the same transformation ratio.

Conversely, a design of the signal transformer 30, 30′ or an arrangement of the tap of the secondary windings 12, 12′ is also possible, in which the current back-transformed onto the primary winding 31 of the signal transformer 30 is increased in order to increase the accuracy during measurement of the switch current(s) I₁₀, I₁₀′.

The embodiments in FIGS. 2 and 3 each illustrate two power circuits 10, 10′. The number of possible power circuits 10 and therefore also the number of possible voltage sources feeding the DC/DC converter can also be greater, however.

In addition to the two voltage sources 11, 11′ shown, in the case of a DC/DC converter for providing an on-board power supply system for an inverter for a photovoltaic system, for example, a rectifier connected to an energy supply system with a buffer capacitor can be used as further voltage source. In this way, a supply of operating current to the inverter is possible at night via the energy supply system and during the day from the intermediate circuit and therefore a photovoltaic generator of the photovoltaic system.

1. A circuit arrangement, comprising:
at least one switching element of a voltage converter;
a DC-isolating signal transformer comprising a primary winding and at least one secondary winding, and configured to receive an actuating signal for the switching element at the primary winding, and wherein the at least one secondary winding is connected to a switching input of the at least one switching element for actuating thereof;
wherein at least a part of the at least one secondary winding is connected in series with a switching path of the at least one switching element in such a way that a switch current flowing through the switching path of the at least one switching element flows through the part of the at least one secondary winding; and
a current measurement device arranged in a series circuit with respect to the primary winding, and configured to determine the switch current.

2. The circuit arrangement as claimed in claim 1, further comprising at least two power circuits, each comprising one switching element connected to different voltage sources, wherein the at least two power circuits share the DC-isolating signal transformer with a primary winding and separate secondary windings for the respective switching elements.

3. The circuit arrangement as claimed in claim 1, further comprising at least two power circuits, each comprising one switching element connected to different voltage sources, wherein each of the at least power circuits comprise a signal transformer, each comprising a primary winding and a secondary winding.

4. The circuit arrangement as claimed in claim 2, further comprising a power transformer comprising at least two primary windings, each arranged in a corresponding one of the power circuits, wherein the at least two primary windings of the power transformer have a different number of turns from one another and the respective secondary windings of the power transformer have a different number of turns from one another, and wherein the turn ratios in the secondary windings are matched to the turn ratios of the primary windings.

5. The circuit arrangement as claimed in claim 1, wherein the current measurement device comprises a shunt.

6. The circuit arrangement as claimed in claim 1, wherein the at least one secondary winding is a winding with a tap, wherein the at least one secondary winding is connected in series with the switching path of the at least one switching element from an end connection up to the tap, whereas a remaining part or the entire secondary winding is operatively connected to the switching input of the at least one switching element.

7. A driver circuit, comprising:
at least one switching element of a voltage converter;
a DC-isolating signal transformer comprising a primary winding and at least one secondary winding connected to a control input of the switching element;
wherein the driver circuit is configured to evaluate a current flowing through the primary winding as a signal corresponding to a switch current flowing through the switching element.

8. The driver circuit as claimed in claim 7, wherein the driver circuit is implemented as an integrated circuit.

9. The driver circuit as claimed in claim 7, further comprising a current measurement device configured to detect and evaluate the current flowing through the primary winding.

10. The driver circuit as claimed in claim 6, further comprising terminals configured to connect to an external current measurement device configured to detect the current flowing through the primary winding.

11. The driver circuit as claimed in claim 7, further comprising terminals configured to connect to an external shunt configured to detect the current flowing through the primary winding.

12. A method, comprising:
switching at least one switching element of a voltage converter via a DC-isolating signal transformer comprising a primary winding and at least one secondary winding, wherein an actuating signal for the at least one switching element is applied to the primary winding, and the secondary winding provides a switching signal for switching the at least one switching element;
transferring a switch current flowing through the switching path of the at least one switching element is transferred to the primary winding via the DC-isolating signal transformer; and
detecting a current flowing through the primary winding as a measure of the switch current.

13. The method as claimed in claim 12, further comprising using a value of the measured switch current as an actuating variable for the generation of the actuating signal.
